(19) United States
(12) Patent Application Publication
(10) Pub. No.: US 2022/0235941 A1
(43) Pub. Date: Jul. 28, 2022

(54) GRILL WITH QUICK CLEANING DEVICE

(71) Applicant: Ningbo Beijixin Technology Co., Ltd., Cixi (CN)

(72) Inventor: Xinyuan Yu, Cixi (CN)

(73) Assignee: Ningbo Beijixin Technology Co., Ltd., Cixi (CN)

(21) Appl. No.: 17/723,505

(22) Filed: Apr. 19, 2022

(30) Foreign Application Priority Data
Mar. 11, 2022 (CN) 202220540597.9

(51) Int. Cl. F24B 13/00; A47J 37/07

(52) U.S. Cl. CPC F24B 13/008; A47J 37/0786

(57) ABSTRACT

The present disclosure provides a grill with a quick cleaning device, including a combustion furnace and a grill cover; wherein the combustion furnace is mounted in the grill cover, and the combustion furnace includes a first cleaning opening, a cleaning control member configured to control open and close of the cleaning opening being movably mounted at the first cleaning opening; and a second cleaning opening is disposed at a position, corresponding to the first cleaning opening, of the grill cover, a cleaning basin being slidably or detachably connected at the position, where the second cleaning opening is disposed, of the grill cover. This structure has the advantages of use convenience and improving use experience of such products.

### TECHNICAL FIELD

The present disclosure relates to the technical field of dust-cleaning for grills, and in particular, relates to a grill with a quick cleaning device.

### BACKGROUND

Pellet grills are heated by combustion of pellets. A conventional pellet grill typically includes a grill body. A combustion chamber is disposed in the grill body. A grilling grid is disposed over the combustion chamber. A feed channel is disposed at a side portion of the grill body, wherein the pellets are transported to the combustion chamber via a screw conveyor mounted at the feed channel. The pellets are combusted in the combustion chamber to generate heat, such that food on the grilling grid is well baked. However, in the conventional grill structure, ashes in the combustion chamber are hard to clean, and ash cleaning is troublesome.

### SUMMARY

The present disclosure is intended to provide a grill with a quick cleaning device to overcome the defect in the related art. The specific structure is as follows.

The present disclosure provides a grill with a quick cleaning device. The grill includes a combustion furnace and a grill cover; wherein the combustion furnace is mounted in the grill cover, and the combustion furnace includes a first cleaning opening, a cleaning control member configured to control open and close of the cleaning opening being movably mounted at the first cleaning opening; and a second cleaning opening is disposed at a position, corresponding to the first cleaning opening, of the grill cover, a cleaning basin being slidably or detachably connected at the position, where the second cleaning opening is disposed, of the grill cover.

Preferably, a hanger is disposed on each of two opposite sides at the position, where the second cleaning opening is disposed, of the grill cover; wherein the two hangers are respectively disposed on two opposite sides of the second cleaning opening, the cleaning basin is disposed between the two hangers, and frame plates on two opposite sides of the cleaning basin are respectively disposed on pallets of the two hangers.

Preferably, limiting bodies are respectively disposed at two ends of the pallets of the two hangers.

Preferably, a first receiving basin is disposed in the cleaning basin; wherein the first receiving basin corresponds to the second cleaning opening in terms of position.

Preferably, a handle is disposed at one end of the cleaning basin.

Preferably, the first cleaning opening and the second cleaning opening are connected via a pipe.

Preferably, the cleaning control member includes a plate body movably disposed between an opening of the pipe and the first cleaning opening, the plate body being provided with a closing portion and a cleaning hole; wherein when the closing portion is disposed between an opening of the pipe and the first cleaning opening, the opening of the pipe is blocked from the first cleaning opening; and when the cleaning hole is disposed between the opening of the pipe and the first cleaning opening, the opening of the pipe is communicated with the first cleaning opening.

Preferably, a pulling portion is disposed on the plate body; wherein a pulling rod is mounted on the pulling portion, the pulling rod penetrates through the grill cover.

Preferably, a third cleaning opening is disposed at a position, above the cleaning basin, of the grill cover; wherein a second receiving basin is disposed under the third cleaning opening. When the third cleaning opening is not used, a cover is disposed at the third cleaning opening.

Preferably, a fourth cleaning opening corresponding to the second receiving basin in terms of position is disposed at the position, above the cleaning basin, of the grill cover; wherein a trash falling pipe is disposed at the fourth cleaning opening. For better receiving of the falling trash, a disc is disposed at an upper end of the trash falling pipe.

In the grill with the quick cleaning device according to the present disclosure, the pulling rod is pulled to cause the plate body to be slided, such that the cleaning hole is disposed between the opening of the pipe and the first cleaning opening, and is communicated with the first cleaning opening. In this way, dust in the combustion furnace after use automatically falls into the first receiving basin. In this case, the cleaning basin is pulled out, and the dust in the first receiving basin is dumped, such that the dust accumulated during the previous use is quickly cleaned. This structure has the advantages of use convenience and improving use experience of such products.

### BRIEF DESCRIPTION OF THE DRAWINGS

FIG. 1 is an overall schematic structural view (1);

FIG. 2 is an overall schematic perspective view (1);

FIG. 3 is a partial view (1);

FIG. 4 is a partial view;

FIG. 5 is an overall schematic perspective view;

FIG. 6 is an enlarged view taken at A; and

FIG. 7 is an overall schematic structural view.

### DETAILED DESCRIPTION

The technical solutions according to the embodiments of the present disclosure are described in detail clearly and completely hereinafter with reference to the accompanying drawings for the embodiments of the present disclosure. Apparently, the described embodiments are only a portion of embodiments of the present disclosure, but not all the embodiments of the present disclosure. Based on the embodiments of the present disclosure, all other embodiments derived by persons of ordinary skill in the art shall fall within the protection scope of the present disclosure.

### Embodiment

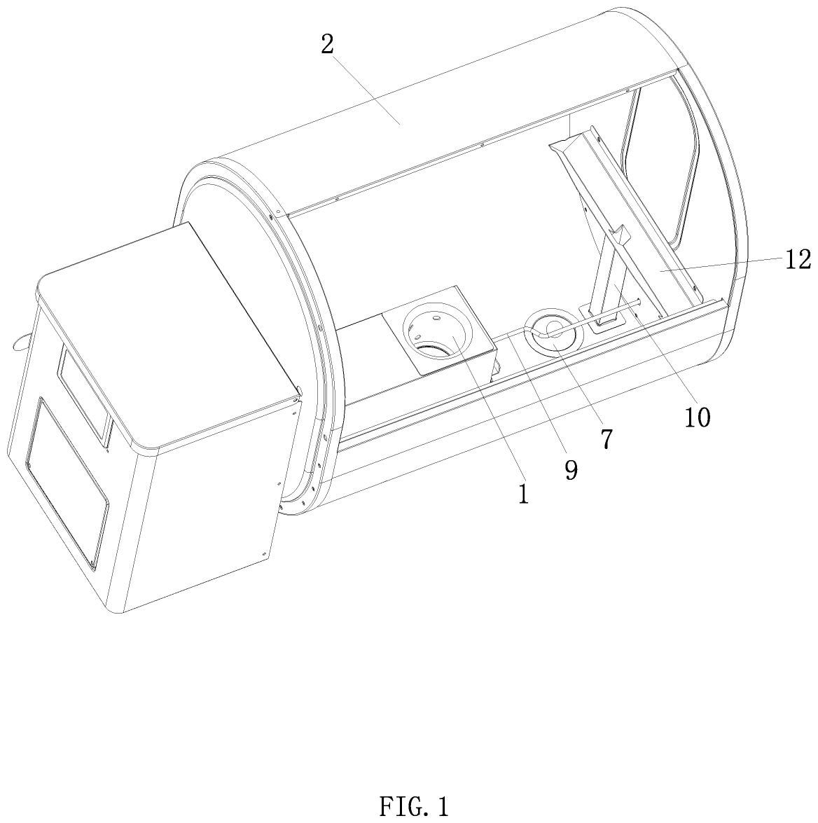

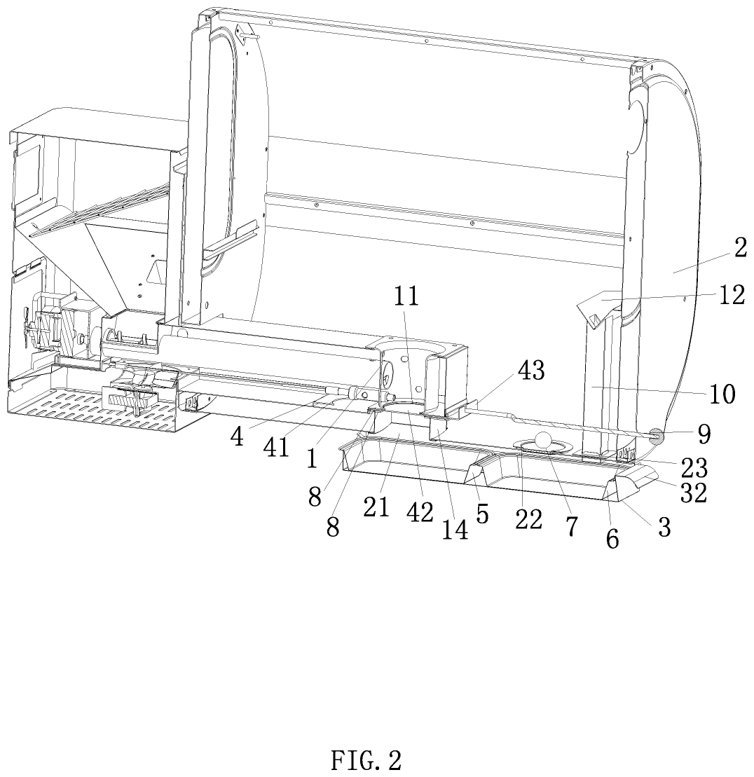

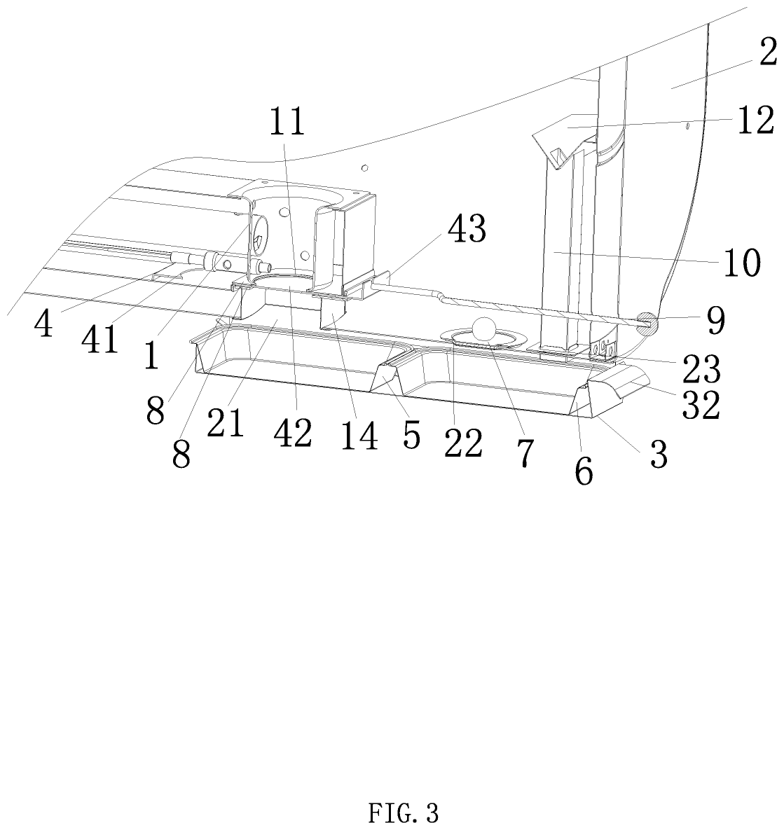

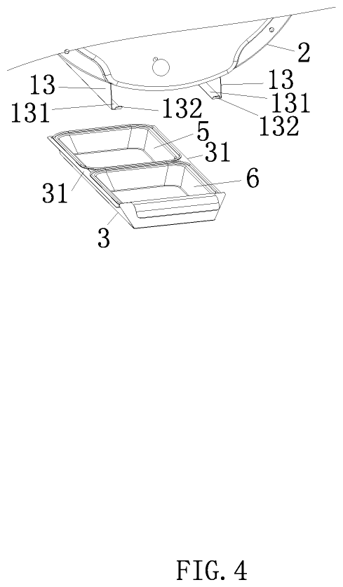

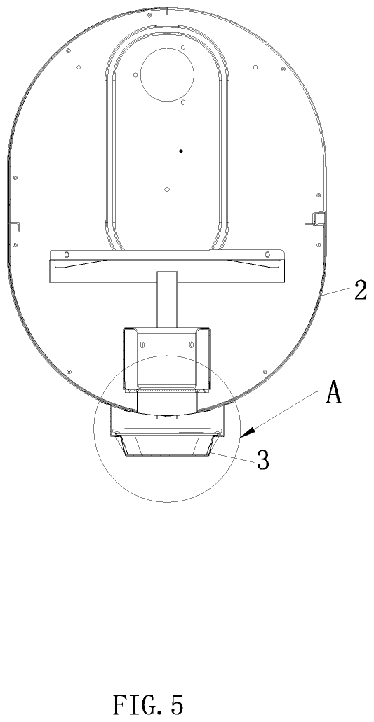

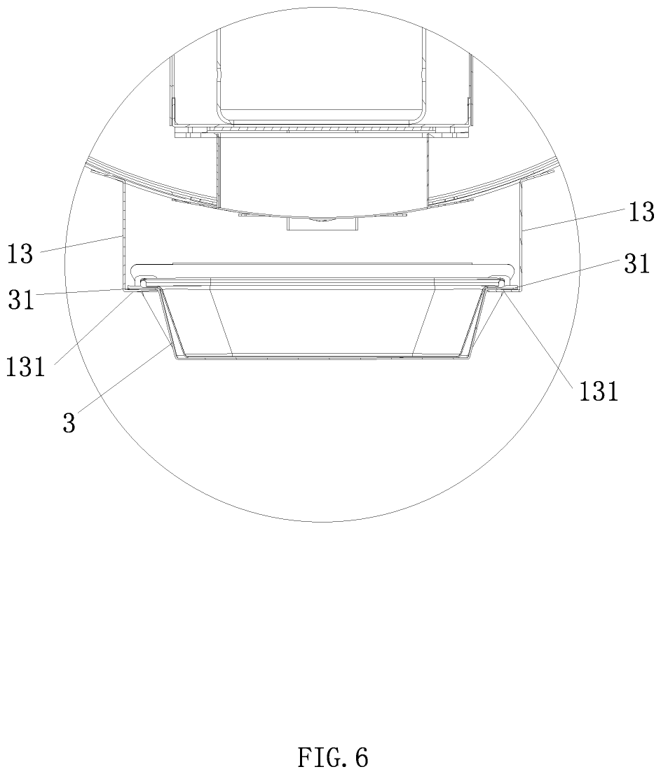

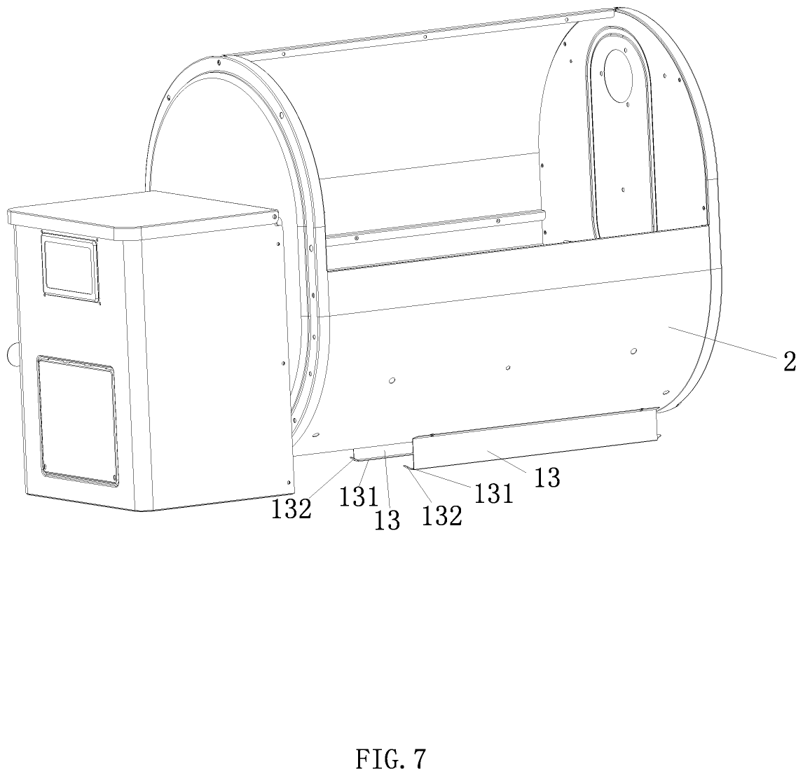

As illustrated in FIG. 1 to FIG. 7, this embodiment provides a grill with a quick cleaning device. The grill includes a combustion furnace 1 and a grill cover 2; wherein the combustion furnace 1 is mounted in the grill cover 2. The combustion furnace 1 includes a first cleaning opening 11. A cleaning control member configured to control open and close of the cleaning opening 11 is movably mounted at the first cleaning opening 11. A second cleaning opening 21 is disposed at a position, corresponding to the first cleaning opening 11, of the grill cover 2. A cleaning basin 3 is slidably or detachably connected at the position, where the second cleaning opening 21 is disposed, of the grill cover 2. Preferably, a receiving basin 5 is disposed in the cleaning basin 3, wherein the first receiving basin 5 corresponds to the second cleaning opening 21 in terms of position. In this case, the cleaning control member is operated to action, such that the first cleaning opening 11 is opened, and then dust automatically falls through the first cleaning opening 11 and the second cleaning opening 21 into the first receiving basin 5. In this case, the cleaning basin 3 may be pulled out, the first receiving basin 5 is taken out from the first cleaning basin 3. Then, the dust in the first receiving basin 5 is dumped. The first receiving basin 5 may be an aluminum foil box.

Preferably, a hanger 13 is disposed on each of two opposite sides at the position, where the second cleaning opening 21 is disposed, of the grill cover 2; wherein the two hangers 13 are respectively disposed on two opposite sides of the second cleaning opening 21, the cleaning basin 3 is disposed between the two hangers 13, and frame plates 31 on two opposite sides of the cleaning basin 3 are respectively disposed on pallets 131 of the two hangers 13. With such structural configuration, the cleaning basin 3 may be slided or detached, wherein with configuration of slidable connection, the cleaning basin 3 and the grill cover 2 are connected via a linear slide guide rail.

Preferably, limiting bodies 132 are respectively disposed at two ends of the pallets 131 of the two hangers 13. Such structural configuration prevents the cleaning basin 3 from being offset during use. The limiting bodies 132 are baffles. The baffles, the hangers 13, and the pallets 131 are integrally formed, and are fixed to the grill cover 2 by screws or by welding.

Preferably, a handle 32 is disposed at one end of the cleaning basin 3, and such structural configuration facilitates pulling out of the cleaning basin 3.

Preferably, the first cleaning opening 11 and the second cleaning opening 21 are connected via a pipe 14. Configuration of the pipe 14 achieves a guide effect for falling of the dust.

Preferably, the cleaning control member includes a plate body 4 movably disposed between an opening of the pipe 14 and the first cleaning opening 11. The plate body 4 is provided with a closing portion 42 and a cleaning hole 41. When the closing portion 42 is disposed between an opening of the pipe 14 and the first cleaning opening 11, the opening of the pipe 14 is blocked from the first cleaning opening 11; and when the cleaning hole 41 is disposed between the opening of the pipe 14 and the first cleaning opening 11, the opening of the pipe 14 is communicated with the first cleaning opening 11. Such structural configuration is simple and has a low cost. A positioning plate 8 is fixed to each of the opening of the pipe 14 and the first cleaning opening 11. Configuration of the positioning plate 8 makes the plate body 4 more stable. Through holes in communication with the first cleaning opening 11 and the opening of the pipe 14 respectively are opened in the positioning plate 8.

Preferably, a pulling portion 43 is disposed on the plate body 4. A pulling rod 9 is mounted on the pulling portion 43. The pulling rod 9 penetrates through the grill cover 2. With such structural configuration, it is convenient for a user to directly operate the plate body 4 from the outside, thereby improving use performance.

Preferably, a third cleaning opening 22 is disposed at a position, above the cleaning basin 3, of the grill cover 2. A second receiving basin 6 is disposed under the third cleaning opening 22. When the third cleaning opening 22 is not used, a cover 7 is disposed at the third cleaning opening 22. With such structural configuration, debris in the grill cover 2 may be cleaned, thereby improving use performance. The second receiving basin 6 may be an aluminum foil box.

Preferably, a fourth cleaning opening 23 corresponding to the second receiving basin 6 in terms of position is disposed at the position, above the cleaning basin 3, of the grill cover 2. A trash falling pipe 10 is disposed at the fourth cleaning opening 23. For better receiving of the falling trash, a disc 12 is disposed at an upper end of the trash falling pipe, such that the use is more convenient.

The present disclosure is not limited to the above described embodiments, and any person could derive other various products under inspiration of the present disclosure. However, any variation in terms of shape or structure shall be considered as falling within the protection scope of the present disclosure as long as the same or similar technical solutions are employed as the present disclosure.

What is claimed is:

1. A grill with a quick cleaning device, comprising a combustion furnace and a grill cover; wherein the combustion furnace is mounted in the grill cover, and the combustion furnace comprises a first cleaning opening, a cleaning control member configured to control open and close of the cleaning opening being movably mounted at the first cleaning opening; and a second cleaning opening is disposed at a position, corresponding to the first cleaning opening, of the grill cover, a cleaning basin being slidably or detachably connected at the position, where the second cleaning opening is disposed, of the grill cover.

2. The grill with the quick cleaning device according to claim 1, wherein a hanger is disposed on each of two opposite sides at the position, where the second cleaning opening is disposed, of the grill cover; wherein the two hangers are respectively disposed on two opposite sides of the second cleaning opening, the cleaning basin is disposed between the two hangers, and frame plates on two opposite sides of the cleaning basin are respectively disposed on pallets of the two hangers.

3. The grill with the quick cleaning device according to claim 2, wherein limiting bodies are respectively disposed at two ends of the pallets of the two hangers.

4. The grill with the quick cleaning device according to claim 3, wherein a first receiving basin is disposed in the cleaning basin; wherein the first receiving basin corresponds to the second cleaning opening in terms of position.

5. The grill with the quick cleaning device according to claim 3, wherein a handle is disposed at one end of the cleaning basin.

6. The grill with the quick cleaning device according to claim 3, wherein the first cleaning opening and the second cleaning opening are connected via a pipe.

7. The grill with the quick cleaning device according to claim 6, wherein the cleaning control member comprises a plate body movably disposed between an opening of the pipe and the first cleaning opening, the plate body being provided with a closing portion and a cleaning hole; wherein when the closing portion is disposed between an opening of the pipe and the first cleaning opening, the opening of the pipe is blocked from the first cleaning opening; and when the cleaning hole is disposed between the opening of the pipe and the first cleaning opening, the opening of the pipe is communicated with the first cleaning opening.

8. The grill with the quick cleaning device according to claim 7, wherein a pulling portion is disposed on the plate body; wherein a pulling rod is mounted on the pulling portion.

9. The grill with the quick cleaning device according to claim 4, wherein a third cleaning opening is disposed at a position, above the cleaning basin, of the grill cover; wherein a second receiving basin is disposed under the third cleaning opening.

10. The grill with the quick cleaning device according to claim 9, wherein a fourth cleaning opening corresponding to the second receiving basin in terms of position is disposed at the position, above the cleaning basin, of the grill cover; wherein a trash falling pipe is disposed at the fourth cleaning opening.
